(19) United States
(12) Patent Application Publication
(10) Pub. No.: US 2008/0129245 A1
(43) Pub. Date: Jun. 5, 2008

(54) Apparatus and method for recharging nonrechargeable batteries

(76) Inventor: Rod Bronson, (US)

Correspondence Address: Rod Bronson, 506 Newport Drive, Lompoc, CA, 93436, US

(21) Appl. No.: 11/978,751

(22) Filed: Oct. 29, 2007

Related U.S. Application Data
(60) Provisional application No. 60/868,530, filed on Dec. 4, 2006.

(51) Int. Cl. H02J 7/02; H01M 10/44

(52) U.S. Cl. 320/107; 320/139

(57) ABSTRACT

An apparatus and method for recharging non-rechargeable batteries. Utilizes a non-zero offset voltage at a non-zero frequency (a combined DC and AC voltage) to charge a “non-rechargeable” DC battery at a desired voltage. The direct current is used to charge a DC battery and the alternating current is used to perform chemical compound ion reversals at a sufficient speed to allow the dc to penetrate the layers of stratified charges created in the battery during normal use discharge. These stratified charge layers normally act as resistances to DC charging when standard DC battery chargers are employed in an attempt to recharge non-rechargeable batteries, such as primary alkaline batteries. The stratified layers act as capacitors to DC, not allowing them to pass the charged layer, but rather resist the DC and create heat and resulting pressure that can eventually cause leakage. The combined waveform results in a superposition of one signal over the other, thus allowing for DC to pass the layer and affect the reversal of the deepest chemical compounds. The result is that the battery is charged safely and more thoroughly than with DC-only charging.

### BACKGROUND OF THE INVENTION

1. Field of the Invention

Embodiments of the invention described herein pertain to the field of electronics. More particularly, but not by way of limitation, one or more embodiments of the invention enable recharging non-rechargeable batteries.

2. Description of the Related Art

Non-rechargeable batteries, for example alkaline batteries are thought to be “non-rechargeable”.

Alkaline batteries manufactured by name-brand manufacturers state that the batteries are not rechargeable and users are warned against recharging the batteries. Some of these batteries for instance are labeled to disclaim that the batteries have the potential to explode or leak if recharged. Some manufacturers have designed specific alkaline batteries for rechargeable use, but those batteries are sold at a higher premium and are only rechargeable with the aid of the manufacturer's charging system. Some new rechargeable alkaline batteries exist with internal chemistries that include a catalyst to control the creation of hydrogen. Even though manufacturers have stated that certain types of batteries are non-rechargeable, devices have been created to charge non-rechargeable batteries using small amounts of direct current (DC) over an extended period of time. Given that batteries are routinely discarded that could be recharged, there is a large potential for saving batteries. The benefits to the consumer and environment are currently ignored as manufacturers do not make profits on non-rechargeable batteries that recharged.

All known devices or circuits that are used to charge non-rechargeable batteries are based on direct current circuits that provide a battery with a small amount of current at a relatively stable fixed voltage level to charge batteries and do not charge to the original condition at which the battery was purchased. Current industry recharging limitations stem from chemical compounds that migrate through the battery due to concentration buildup and heat generated by discharge reactions. In addition, some vapors exit through case vents. The by-products are reversible if not completely lost from the matrix and reaching the by-products with recycle charging electronics has been the challenge of all Primary alkaline users who wish to recharge.

For at least the limitations described above there is a need for an apparatus and method for recharging non-rechargeable batteries.

### BRIEF SUMMARY OF THE INVENTION

One or more embodiments of the invention enable an apparatus and method for recharging “non-rechargeable” batteries. The apparatus utilizes a non-zero offset voltage at a non-zero frequency (a combined DC and AC voltage) to charge a “non-rechargeable” DC battery at a desired voltage. Embodiments have been utilized to recharge non-rechargeable batteries that meet ANSI C18.1 Part 1-2001 for “New Battery Life”.

Specifically, embodiments of the apparatus utilize a combined direct current (DC) and alternating current (AC) waveform, hereinafter a “combined waveform”, to charge “non-rechargeable” batteries. The direct current is used to charge a DC battery and the alternating current is used to perform chemical compound ion reversals at a sufficient speed to allow the DC to penetrate the layers of stratified charges created in the battery during normal use discharge.

These stratified charge layers normally act as resistances to DC charging when standard DC battery chargers are employed in an attempt to recharge non-rechargeable batteries, such as primary alkaline batteries. The stratified layers act as capacitors to DC, not allowing them to pass the charged layer, but rather resist the DC and create heat and resulting pressure that can eventually cause leakage.

The combined waveform results in a superposition of one signal over the other, thus allowing for DC to pass the layer and affect the reversal of the deepest chemical compounds. The result is that the battery is charged safely and more thoroughly than with DC-only charging.

Many type of circuits may be utilized to provide AC and DC combined waveforms for charging and the exemplary circuits shown herein may be extended to add other features allowing for more precise charging and or other features such as indicators or safety features.

A method for charging a non-rechargeable battery(s) includes coupling a DC circuit with an AC circuit to form a charging circuit. The DC circuit and AC circuit may be coupled in any manner using any technology such as circuit board coupling or soldering. The charging circuit may utilize any DC value along with any AC waveform. In one embodiment, a rectified sine wave with slight gaps for diode voltage drops that allows for charging non-rechargeable batteries when the voltage is higher than the non-rechargeable battery voltage. The positive and negative terminals are coupled with the charging circuit. For embodiments that utilize an external power source the power terminal may be coupled to the power source. Some embodiments may utilize a case to protect users from touching electrical components and the case is coupled to the charging circuit in these embodiments. The case may be constructed of any material and may include insulating materials that isolate the charging circuitry from the external portion of the case as required by any state, federal or international regulatory agency. The positive and negative terminals may be configured to contact one battery, more than one battery in series or more than one battery in parallel.

For applications where large numbers of batteries are to be simultaneously charged, a parallel configuration that provides a combined AC and DC waveform may be placed across all batteries at once. In this embodiment, if one of the batteries is already nearly charged, then the battery will charge the remainder at a slower rate than a battery that is not as charged at charge start time.

Alternatively, a series of batteries may be charged at once. In either case, the voltage applied by an embodiment of the charging circuit contains an alternating current at any DC voltage offset. Processing ends at 407.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an embodiment of a combined waveform utilized in embodiments of the invention to charge “non-rechargeable” batteries.

FIG. 2 illustrates an architecture diagram for an embodiment of the invention.

FIG. 3 illustrates an embodiment of a circuit for applying a full-wave rectified alternating current to a direct current target battery.

FIG. 4 illustrates a method for charging a non-rechargeable battery.

### DETAILED DESCRIPTION

An apparatus and method for recharging non-rechargeable batteries will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

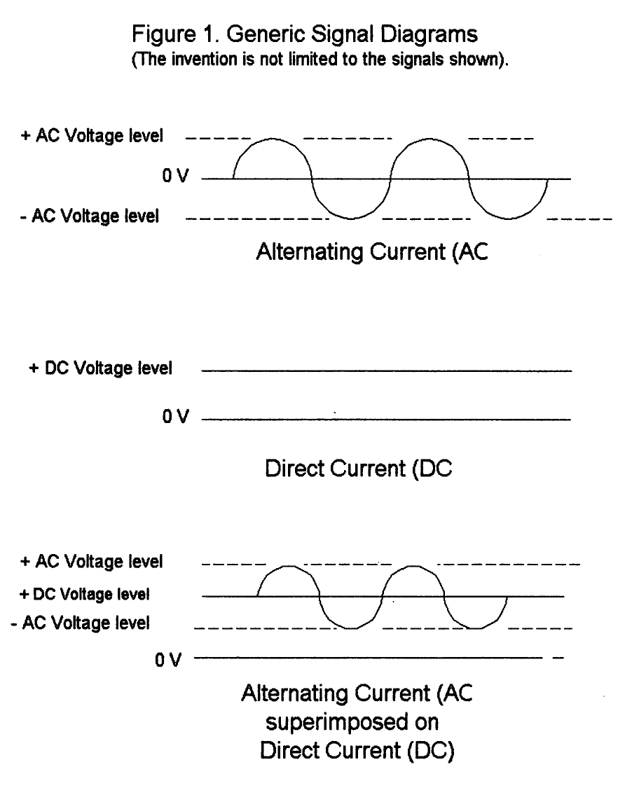

One or more embodiments of the invention enable an apparatus and method for recharging “non-rechargeable” batteries. The apparatus utilizes a non-zero offset voltage at a non-zero frequency (a combined DC and AC voltage) to charge a “non-rechargeable” DC battery at a desired voltage. Specifically, embodiments of the apparatus utilize a combined direct current (DC) and alternating current (AC) waveform, hereinafter a “combined waveform”, to charge “non-rechargeable” batteries. FIG. 1 illustrates an embodiment of a combined waveform utilized in embodiments of the invention to charge “non-rechargeable” batteries. In the top of the figure an alternating current signal, here a sine wave, is shown that varies between +AC volts and −AC volts. In the center of the diagram, a DC offset voltage is shown at +DC volts. The AC signal and the DC signal are combined to form the waveform at the bottom of FIG. 1, namely an AC signal superimposed on a DC signal. This is but one example of a signal that is utilized with embodiments of the invention and sine waves are but one example of the alternating component of the waveform that is applied to one or more non-rechargeable batteries.

The direct current is used to charge a DC battery and the alternating current is used to perform chemical compound ion reversals at a sufficient speed to allow the DC to penetrate the layers of stratified charges created in the battery during normal use discharge. These stratified charge layers normally act as resistances to DC charging when standard DC battery chargers are employed in an attempt to recharge non-rechargeable batteries, such as primary alkaline batteries. The stratified layers act as capacitors to DC, not allowing them to pass the charged layer, but rather resist the DC and create heat and resulting pressure that can eventually cause leakage. The combined waveform results in a superposition of one signal over the other, thus allowing for DC to pass the layer and affect the reversal of the deepest chemical compounds. The result is that the battery is charged safely and more thoroughly than with DC-only charging.

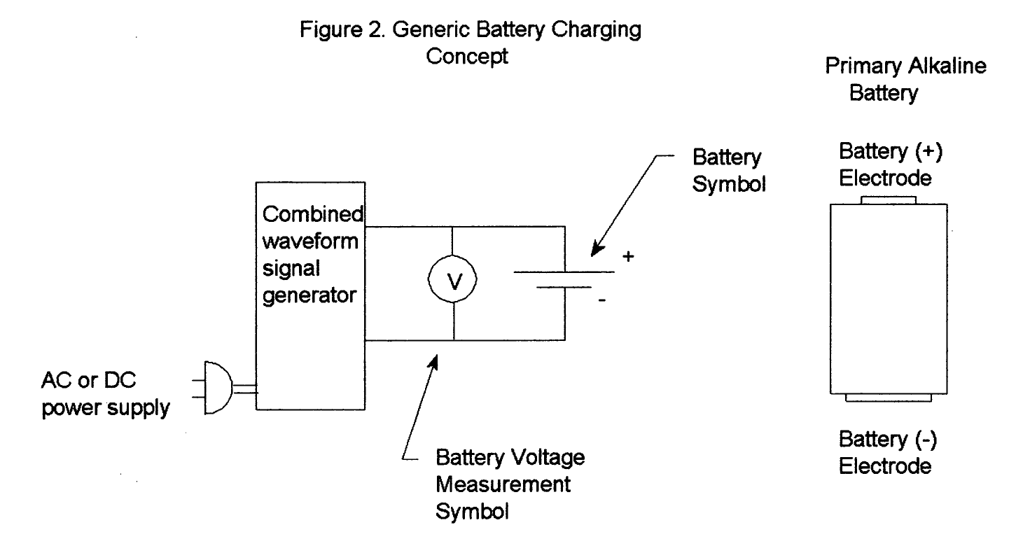

FIG. 2 illustrates an architecture diagram for an embodiment of the invention. In this figure, the AC component of FIG. 1 and the DC component of FIG. 1 are combined together by the “Combined waveform signal generator” and output to one or more non-rechargeable batteries that are shown on the right of the diagram. Once the AC or DC power supply is coupled to an embodiment of the invention, the embodiment charges one or more non-rechargeable batteries, for example primary alkaline batteries.

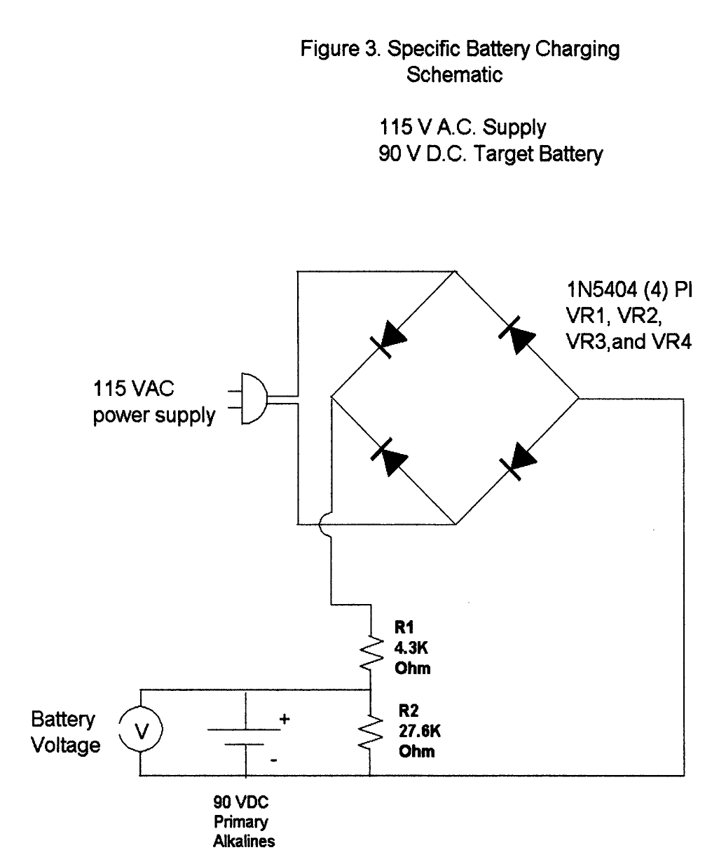

FIG. 3 illustrates an embodiment of a circuit for applying a full-wave rectified alternating current to a direct current target battery. In this simple embodiment the full-wave rectifying portion of the charging circuit is shown as a configuration of four diodes. The loss from the diodes in the circuit is less than 1 volt generally and in this particular example a rectified sine wave with both upper and lower swings are rectified to reflect above zero volts. A series of voltage “humps” results that is utilized to charge at least one non-rechargeable battery. In this case, a parallel configuration of sixty 1.5 volt AA batteries is charged. When the voltage from the 115 RMS power supply is rectified and is greater than the battery voltage, current flows into the battery and the battery is charged. Any other type of circuit that applies any type of alternating current to a direct current battery is in keeping with the spirit of the invention. The diodes used in this simplified embodiment are 1N5404 with a sufficient peak reverse voltage rating for the supply voltage utilized. The resulting signal has some component of AC ripple inherent and most power supply manufactures filter this AC component out for a DC charging system. The resulting signal is voltage divided by R2/(R1+R2) and the combined resistors R1+R2 limit the current in the charging loop to a safe amount.

Use of more sophisticated circuits that do not discharge when the power supply is disconnected or that include indicators to display when a non-rechargeable battery is charged or not charged may be added as one skilled in the art will recognize. In the exemplary circuit, the voltage divider 27.6 k Ohms divided by the sum of 4.3 k and 27.6 k Ohms provides a percentage of voltage that the 115 VAC RMS power supply provides. In one or more embodiments of the invention, a 3% peak voltage above the desired target voltage is applied to the non-rechargeable battery(s). In another embodiment a 10% peak voltage above the desired target voltage is applied. In either case, the applied voltage may include the alternating current component or not so long as an alternating current is applied to a direct current battery and any peak voltage above the desired target voltage that successfully charges the battery may be utilized.

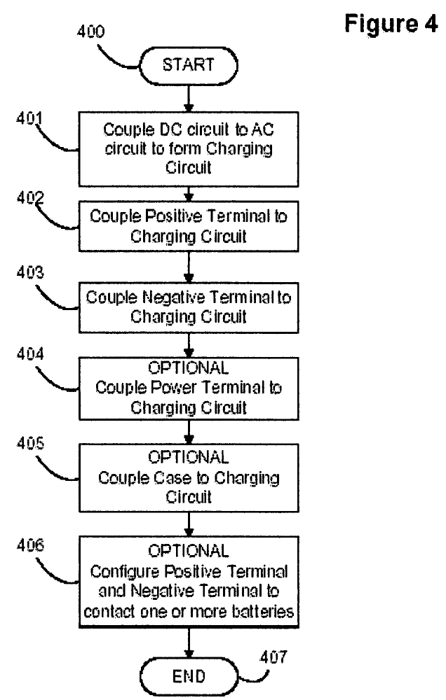

FIG. 4 illustrates a method for charging a non-rechargeable battery. Processing starts at 400 and a DC circuit is coupled with an AC circuit to form a charging circuit at 401. The DC circuit and AC circuit may be coupled in any manner using any technology such as circuit board coupling or soldering. Any method of coupling an AC circuit with a DC circuit is in keeping with the spirit of the invention. The charging circuit may utilize any DC value along with any AC waveform. The exemplary circuit shown in FIG. 3 for example outputs a rectified sine wave with slight gaps to account for the diode voltage drops that allows for charging non-rechargeable batteries when the voltage is higher than the non-rechargeable battery voltage.

The positive terminal is coupled with the charging circuit at 402. Any type of terminal may be utilized so long as a non-rechargeable positive electrode is capable of being coupled with the positive terminal. Likewise, the negative terminal is coupled with the charging circuit at 403 and similarly any type of terminal may be utilized for the negative terminal so long as the negative terminal is capable of coupling with a non-rechargeable battery. For embodiments that utilize an external power source the power terminal may be coupled to the power source at 404. Some embodiments may utilize a case to protect users from touching electrical components and the case is coupled to the charging circuit at 405. The case may be constructed of any material and may include insulating materials that isolate the charging circuitry from the external portion of the case as required by any state, federal or international regulatory agency. The positive and negative terminals may be configured to contact one battery, more than one battery in series or more than one battery in parallel at 406. For applications where large numbers of batteries are to be simultaneously charged, a parallel configuration that provides a combined AC and DC waveform may be placed across all batteries at once. In this embodiment, if one of the batteries is already nearly charged, then the battery will charge the remainder at a slower rate than a battery that is not as charged at charge start time. Alternatively, a series of batteries may be charged at once. In either case, the voltage applied by an embodiment of the charging circuit contains an alternating current at any DC voltage offset. Processing ends at 407.

While the invention herein disclosed has been described by means of specific embodiments and applications thereof, numerous modifications and variations could be made thereto by those skilled in the art without departing from the scope of the invention set forth in the claims.

What is claimed is:

1. An apparatus for recharging non-rechargeable batteries comprising:
an alternating current circuit;
a direct current circuit coupled with said alternating current circuit that forms a charging circuit wherein said alternating current circuit and said direct current circuit are combined into a non-zero voltage offset signal having a non-zero frequency;
a positive terminal;
a negative terminal; and,
said alternating current circuit and said direct current circuit coupled with said positive terminal and said negative terminal and configured to deliver said non-zero voltage offset signal having said non-zero frequency to a non-rechargeable battery coupled with said positive terminal and said negative terminal.

2. The apparatus for recharging non-rechargeable batteries of claim 1 further comprising:
a power terminal configured to obtain a source voltage.

3. The apparatus for recharging non-rechargeable batteries of claim 1 further comprising:
a case configured to hold said charging circuit and expose said positive terminal and said negative terminal.

4. The apparatus for recharging non-rechargeable batteries of claim 3 wherein said positive terminal and said negative terminal are coupled with one battery.

5. The apparatus for recharging non-rechargeable batteries of claim 3 wherein said positive terminal and said negative terminal are coupled with a plurality of batteries in series.

6. The apparatus for recharging non-rechargeable batteries of claim 3 wherein said positive terminal and said negative terminal are coupled with a plurality of batteries in parallel.

7. The apparatus for recharging non-rechargeable batteries of claim 1 wherein said charging circuit outputs a charging voltage within 3% of a target DC voltage.

8. The apparatus for recharging non-rechargeable batteries of claim 1 wherein said charging circuit outputs a charging voltage within 10% of a target DC voltage.

9. The apparatus for recharging non-rechargeable batteries of claim 1 further comprising:
an indicator configured to indicate when said non-rechargeable battery is not charged.

10. The apparatus for recharging non-rechargeable batteries of claim 1 further comprising:
an indicator configured to indicate when said non-rechargeable battery is charged.

11. A method for recharging non-rechargeable batteries comprising:
coupling a direct current circuit with an alternating current circuit to form a charging circuit wherein said alternating current circuit and said direct current circuit are configured to provide a non-zero voltage offset signal having a non-zero frequency;
coupling a positive terminal to said charging circuit; and,
coupling a negative terminal to said charging circuit.

12. The method for recharging non-rechargeable batteries of claim 11 further comprising:
coupling a power terminal to said charging circuit wherein said power terminal is configured to obtain a source voltage.

13. The method for recharging non-rechargeable batteries of claim 11 further comprising:
coupling a case configured to hold said charging circuit.

14. The method for recharging non-rechargeable batteries of claim 11 further comprising:
exposing said positive terminal and said negative terminal.

15. The method for recharging non-rechargeable batteries of claim 11 further comprising:
configuring said positive terminal and said negative terminal to couple with one battery.

16. The method for recharging non-rechargeable batteries of claim 11 further comprising:
configuring said positive terminal and said negative terminal to couple with a plurality of batteries in series.

17. The method for recharging non-rechargeable batteries of claim 11 further comprising:
configuring said positive terminal and said negative terminal to couple with a plurality of batteries in parallel.

18. The method for recharging non-rechargeable batteries of claim 11 further comprising:
indicating when said non-rechargeable battery is not charged and when said non-rechargeable battery is charged.

19. A method for recharging non-rechargeable batteries comprising:
delivering said non-zero voltage offset signal having said non-zero frequency from said charging circuit to a non-rechargeable battery in contact with said positive terminal and said negative terminal.

20. A charged non-rechargeable battery made by the process of claim 19.
